(19) United States
(12) Patent Application Publication
(10) Pub. No.: US 2026/0250435 A1
(43) Pub. Date: Aug. 27, 2026

(54) COUPLING AGENTS

(71) Applicant: Lubrizol Advanced Materials, Inc., Cleveland, OH (US)

(72) Inventors: Robert A. Jennings, Manchester (GB); Andrew J. Shooter, Wilmslow (GB); Michael Collinge, Manchester (GB); Christopher Lowe, Manchester (GB); Dean Thetford, Rochdale (GB)

(73) Assignee: Lubrizol Advanced Materials, Inc, Cleveland, OH (US)

(21) Appl. No.: 18/871,275

(22) PCT Filed: Jun. 8, 2023
(86) PCT No.: PCT/US2023/024775

§ 371 Date: Dec. 3, 2024

Related U.S. Application Data
(60) Provisional application No. 63/350,633, filed on Jun. 9, 2022.

(51) Int. Cl. C08F 24/00; C08K 3/26

(52) U.S. Cl. CPC C08F 24/00; C08K 3/26; C08K 2003/265

(57) ABSTRACT

Disclosed are thermoset compositions including a dispersion of a particulate solid into a thermosetting resin in the presence of a coupling agent according to formula I described herein. Various methods of making and/or using the coupling agent and/or the thermoset compositions are also disclosed.

The disclosed technology relates to a polymer which may be used as a coupling agent, such as in thermoset compositions including particulate solids.

The incorporation of particulate solids (e.g., fillers and/or fibers) into polymeric materials (such as thermosetting polymers, thermoplastic polymers, elastomers, and/or rubber) is known; the combination of these materials represent a subset of composite material. Molded articles made from these types of composite materials may exhibit improved stiffness, hardness, and/or creep resistance, as compared with corresponding un-filled polymeric materials.

However, these types of composite materials may exhibit a marked decrease in toughness and/or ductility, as compared with corresponding un-filled polymeric materials. In the cases of thermoplastic polymer and thermosetting polymers, composite molded articles may become too brittle, or too low in impact resistance and elongation to be of much practical use.

Various approaches have been attempted to improve compatibility of the particulate solid with the polymeric materials to improve such deficiencies. For example, incorporating a surface modifier or sizing agent, such as by coating the particulate solid, may improve compatibility. The surface modifier/sizing agent may generally fall within two categories: coupling agents and non-coupling modifiers. Non-coupling modifiers interact with the surface of the particulate solid, but do not interact with the polymer matrix.

Coupling agents interact with both the surface of the particulate solid and the polymer matrix. In many cases, coupling agents covalently bond to both the particulate solid and the polymer matrix. In other cases, an ion-pair interaction between the coupling agent and the particulate solid may be adequate, while chain entanglement and/or co-crystallization may provide a sufficient interaction between the coupling agent and the polymer matrix.

For example, acid-functional modifiers may be represented in both categories. Certain fatty acids may typically be considered non-coupling modifiers, where the carboxylic group binds to the surface of the particulate solid and the fatty group intercalates with the polymer matrix. Certain polymeric acids may generally be regarded as coupling agents, where the carboxy group interacts with the surface of the particulate solid, and the polymeric chain interacts with the polymer matrix. The extent of the interaction between the polymeric chain and the polymer matrix depends on the functionality of the polymeric chain and the type of polymeric material. Acrylic acid has been used as a coupling agent for calcium carbonate fillers in a polypropylene matrix, for example, but the volatility of acrylic acid during processing represents a distinct disadvantage.

Organosilanes are currently in use as coupling agents. Organosilanes contain alkoxy silane groups which may react with suitable hydroxyl groups on the surface of the particulate solid (for example, in the case of metal-hydroxide fillers, [metal]-O—Si covalent bonds are formed). The organosilane coupling agent also has another functional group which can react with the polymer matrix. A large range of commercially-available organosilane coupling agents are available to cope with surface hydroxyl groups of varying reactivities, and different reactions with the polymer chains in the matrix. Organosilanes can be quite effective, but they do have certain limitations. For instance, they may be relatively expensive because of the sophisticated chemical processing required, they may be ineffective for fillers which do not have surface hydroxyl groups, they may have limited compatibility with bulk polymer materials used (and thus may be applied as a surface treatment on the particulate solid, requiring additional process steps and/or limiting processing conditions), and they may release significant amounts of alcohols when reacting with certain particulate solids' surfaces.

The disclosed technology, therefore, provides polymers, useful as coupling agents, which may overcome certain deficiencies mentioned above.

The subject matter disclosed herein provides a polymer having monomeric units a, b, c, d, and e according to formula I:

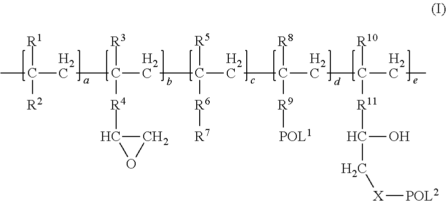

wherein, independently for each molecule of the polymer:
R¹ is H or CH₃;
R² is H, a C₁ to C₂₀ alkyl group, a C₆ to C₁₀ aryl group, a C₇ to C₁₄ alkaryl group, or a C₄ to C₆ cycloalkyl group;
R³ is H or CH₃;
R⁴ is a C₁ to C₂₀ alkyl group, —C—O—R¹²—, or —(C═O)—O—C—R¹²—, wherein R¹² is a C₁ to C₂₀ alkyl group;
R⁵ is H or CH₃;
R⁶ is —C—O— or —(C═O)—O—C—;
R⁷ is a C₁ to C₂₀ alkyl group;
R⁸ is H or CH₃;
R⁹ is a C₁ to C₂₀ alkyl group, —C—O—R¹⁴—, or —(C═O)—O—C—R¹⁴—, wherein R¹⁴ is a C₁ to C₂₀ alkyl group;
R¹⁰ is H or CH₃;
R¹¹ is a C₁ to C₂₀ alkyl group, —C—O—R¹⁵—, or —(C═O)—O—C—R¹⁵—, wherein R¹⁵ is a C₁ to C₂₀ alkyl group;
POL¹ is a polymer comprising at least one of a polyether or a polyester, wherein the polymer has a theoretical-number-average molecular weight of from 200 to 3,000;
POL² is a polymer comprising at least one of a polyether or a polyester, wherein the polymer has a theoretical-number-average molecular weight of from 200 to 3,000;
X is S, O, NH, or —O—(C═O)—;
a is an integer from 1 to 500;
b is an integer from 1 to 500;
c is 0, or an integer from 1 to 100;
d is 0, or an integer from 1 to 100; and
e is 0, or an integer from 1 to 100.

In certain embodiments, the polymer may be used as a coupling agent in a thermoset composition. For example, a thermoset composition may comprise a dispersion of a particulate solid into a thermosetting resin in the presence of the coupling agent.

Also provided are various methods of making and/or using the polymer, the coupling agent, and/or the thermoset composition.

The following embodiments of the present subject matter are contemplated:
1. A thermoset composition comprising a dispersion of a particulate solid into a thermosetting resin in the presence of a coupling agent comprising monomeric units a, b, c, d, and e according to formula I:

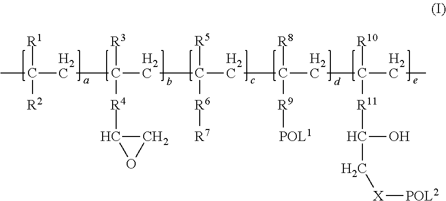

wherein, independently for each molecule of the coupling agent:
R¹ is H or CH₃;
R² is H, a C₁ to C₂₀ alkyl group, a C₆ to C₁₀ aryl group, a C₇ to C₁₄ alkaryl group, or a C₄ to C₆ cycloalkyl group;
R³ is H or CH₃;
R⁴ is a C₁ to C₂₀ alkyl group, —C—O—R¹²—, or —(C═O)—O—C—R¹²—, wherein R¹² is a C₁ to C₂₀ alkyl group;
R⁵ is H or CH₃;
R⁶ is —C—O— or —(C═O)—O—C—;
R⁷ is a C₁ to C₂₀ alkyl group;
R⁸ is H or CH₃;
R⁹ is a C₁ to C₂₀ alkyl group, —C—O—R¹⁴—, or —(C═O)—O—C—R¹⁴—, wherein R¹⁴ is a C₁ to C₂₀ alkyl group;
R¹⁰ is H or CH₃;
R¹¹ is a C₁ to C₂₀ alkyl group, —C—O—R¹⁵—, or —(C═O)—O—C—R¹⁵—, wherein R¹⁵ is a C₁ to C₂₀ alkyl group;
POL¹ is a polymer comprising at least one of a polyether or a polyester, wherein the polymer has a theoretical-number-average molecular weight of from 200 to 3,000;
POL² is a polymer comprising at least one of a polyether or a polyester, wherein the polymer has a theoretical-number-average molecular weight of from 200 to 3,000;
X is S, O, NH, or —O—(C═O)—;
a is an integer from 1 to 500;
b is an integer from 1 to 500;
c is 0, or an integer from 1 to 100;
d is 0, or an integer from 1 to 100; and
e is 0, or an integer from 1 to 100;
with the proviso that if d is greater than 0, e is 0, and if e is greater than 0, d is 0.
2. The thermoset composition of embodiment 1, wherein the particulate solid is present in an amount of from 20 to 80 weight percent, based on the total weight of the thermoset composition.
3. The thermoset composition of either embodiment 1 or embodiment 2, wherein the particulate solid comprises at least one of an extender, a reinforcing material, or a functional filler.
4. The thermoset composition of embodiment 3, wherein the extender comprises at least one of calcium carbonate, talc, barium sulfate, alumina, or quartz.
5. The thermoset composition of either embodiment 3 or embodiment 4, wherein the reinforcing material comprises at least one type of fibrous material.
6. The thermoset composition of any one of embodiments 3 to 5, wherein the functional filler comprises at least one of flame retardant materials or pigments.
7. The thermoset composition of any one of embodiments 1 to 6, wherein the thermosetting resin is present in an amount of from 80 to 20 weight percent, based on the total weight of the thermoset composition.
8. The thermoset composition of any one of embodiments 1 to 7, wherein the thermosetting resin comprises an epoxide resin, an unsaturated polyester resin, a vinyl ester resin, a polyurethane resin, or a phenolic resin.
9. The thermoset composition of any one of embodiments 1 to 8, wherein the coupling agent is present in an amount of from 0.5 to 5 weight percent, based on the total weight of the thermoset composition.
10. The thermoset composition of any one of embodiments 1 to 9, wherein the coupling agent comprises at least 90 percent by weight monomeric units a, b, c, d, and e, according to formula I, based on the total weight of the coupling agent.
11. The thermoset composition of any one of embodiments 1 to 10, wherein the coupling agent comprises at least 70 percent by weight monomeric units a and b, according to formula I, based on the total weight of the coupling agent.
12. The thermoset composition of any one of embodiments 1 to 11, wherein the coupling agent comprises no more than 30 percent by weight monomeric units c, d, and e, according to formula I, based on the total weight of the coupling agent.
13. The thermoset composition of any one of embodiments 1 to 12, wherein the coupling agent comprises at least 50 percent by weight monomeric units a, according to formula I, based on the total weight of the coupling agent.
14. The thermoset composition of any one of embodiments 1 to 13, wherein the coupling agent comprises no more than 40 percent by weight monomeric units b, according to formula I, based on the total weight of the coupling agent.
15. The thermoset composition of any one of embodiments 1 to 14, wherein a is an integer from 5 to 500.
16. The thermoset composition of any one of embodiments 1 to 15, wherein a is an integer from 10 to 300.
17. The thermoset composition of any one of embodiments 1 to 16, wherein b is an integer from 2 to 100.
18. The thermoset composition of any one of embodiments 1 to 17, wherein b is an integer from 5 to 80.
19. The thermoset composition of any one of embodiments 1 to 18, wherein the ratio of a to b is from 1:1 to 10:1.
20. The thermoset composition of any one of embodiments 1 to 19, wherein c is an integer from 1 to 20.
21. The thermoset composition of any one of embodiments 1 to 20, wherein: (i) dis 0, or an integer from 1 to 20; and (ii) e is 0, or an integer from 1 to 20; with the proviso that if d is greater than 0, e is 0, and if e is greater than 0, d is 0.
22. The thermoset composition of any one of embodiments 1 to 21, wherein the coupling agent comprises up to 10 percent by weight other monomeric units, different from monomeric units a, b, c, d, and e according to formula I.
23. The thermoset composition of embodiment 22, wherein the other monomeric units are vinyl-functional monomeric units.

Various features and embodiments of the present subject matter will be described below by way of non-limiting illustration.

As used herein, the indefinite article “a”/“an” is intended to mean one or more than one. As used herein, the phrase “at least one” means one or more than one of the following terms. Thus, “a”/“an” and “at least one” may be used interchangeably. For example “at least one of A, B or C” means that just one of A, B or C may be included, and any mixture of two or more of A, B and C may be included, in alternative embodiments.

As used herein, the term “substantially” means that a value of a given quantity is within ±10% of the stated value. In other embodiments, the value is within ±5% of the stated value. In other embodiments, the value is within ±2.5% of the stated value. In other embodiments, the value is within ±1% of the stated value.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

Provided is a thermoset composition comprising a dispersion of a particulate solid into a thermosetting resin in the presence of a coupling agent comprising monomeric units a, b, c, d, and e according to formula I:

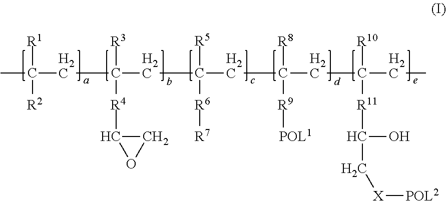

wherein, independently for each molecule of the coupling agent:
R¹ is H or CH₃;
R² is H, a C₁ to C₂₀ alkyl group, a C₆ to C₁₀ aryl group, a C₇ to C₁₄ alkaryl group, or a C₄ to C₆ cycloalkyl group;
R³ is H or CH₃;
R⁴ is a C₁ to C₂₀ alkyl group, —C—O—R¹²—, or —(C═O)—O—C—R¹²—, wherein R¹² is a C₁ to C₂₀ alkyl group;
R⁵ is H or CH₃;
R⁶ is —C—O— or —(C═O)—O—C—;
R⁷ is a C₁ to C₂₀ alkyl group;
R⁸ is H or CH₃;
R⁹ is a C₁ to C₂₀ alkyl group, —C—O—R¹⁴—, or —(C═O)—O—C—R¹⁴—, wherein R¹⁴ is a C₁ to C₂₀ alkyl group;
R¹⁰ is H or CH₃;
R¹¹ is a C₁ to C₂₀ alkyl group, —C—O—R¹⁵—, or —(C═O)—O—C—R¹⁵—, wherein R¹⁵ is a C₁ to C₂₀ alkyl group;
POL¹ is a polymer comprising at least one of a polyether or a polyester, wherein the polymer has a theoretical-number-average molecular weight of from 200 to 3,000 (such as from 250 to 3,000, from 300 to 3,000, from 350 to 3,000, from 400 to 3,000, from 450 to 3,000, from 500 to 3,000, from 600 to 3,000, from 700 to 3,000, from 800 to 3,000, from 900 to 3,000, from 1,000 to 3,000, from 1,200 to 3,000, from 1,400 to 3,000, from 1,600 to 3,000, from 1,800 to 3,000, from 2,000 to 3,000, from 2,500 to 3,000, from 200 to 2,500, from 250 to 2,500, from 300 to 2,500, from 350 to 2,500, from 400 to 2,500, from 450 to 2,500, from 500 to 2,500, from 600 to 2,500, from 700 to 2,500, from 800 to 2,500, from 900 to 2,500, from 1,000 to 2,500, from 1,200 to 2,500, from 1,400 to 2,500, from 1,600 to 2,500, from 1,800 to 2,500, from 2,000 to 2,500, from 200 to 2,000, from 250 to 2,000, from 300 to 2,000, from 350 to 2,000, from 400 to 2,000, from 450 to 2,000, from 500 to 2,000, from 600 to 2,000, from 700 to 2,000, from 800 to 2,000, from 900 to 2,000, from 1,000 to 2,000, from 1,200 to 2,000, from 1,400 to 2,000, from 1,600 to 2,000, from 1,800 to 2,000, from 200 to 1,800, from 250 to 1,800, from 300 to 1,800, from 350 to 1,800, from 400 to 1,800, from 450 to 1,800, from 500 to 1,800, from 600 to 1,800, from 700 to 1,800, from 800 to 1,800, from 900 to 1,800, from 1,000 to 1,800, from 1,200 to 1,800, from 1,400 to 1,800, from 1,600 to 1,800, from 200 to 1,600, from 250 to 1,600, from 300 to 1,600, from 350 to 1,600, from 400 to 1,600, from 450 to 1,600, from 500 to 1,600, from 600 to 1,600, from 700 to 1,600, from 800 to 1,600, from 900 to 1,600, from 1,000 to 1,600, from 1,200 to 1,600, from 1,400 to 1,600, from 200 to 1,400, from 250 to 1,400, from 300 to 1,400, from 350 to 1,400, from 400 to 1,400, from 450 to 1,400, from 500 to 1,400, from 600 to 1,400, from 700 to 1,400, from 800 to 1,400, from 900 to 1,400, from 1,000 to 1,400, from 1,200 to 1,400, from 200 to 1,200, from 250 to 1,200, from 300 to 1,200, from 350 to 1,200, from 400 to 1,200, from 450 to 1,200, from 500 to 1,200, from 600 to 1,200, from 700 to 1,200, from 800 to 1,200, from 900 to 1,200, from 1,000 to 1,200, from 200 to 1,000, from 250 to 1,000, from 300 to 1,000, from 350 to 1,000, from 400 to 1,000, from 450 to 1,000, from 500 to 1,000, from 600 to 1,000, from 700 to 1,000, from 800 to 1,000, from 900 to 1,000, from 200 to 900, from 250 to 900, from 300 to 900, from 350 to 900, from 400 to 900, from 450 to 900, from 500 to 900, from 600 to 900, from 700 to 900, from 800 to 900, from 200 to 800, from 250 to 800, from 300 to 800, from 350 to 800, from 400 to 800, from 450 to 800, from 500 to 800, from 600 to 800, from 700 to 800, from 200 to 700, from 250 to 700, from 300 to 700, from 350 to 700, from 400 to 700, from 450 to 700, from 500 to 700, from 600 to 700, from 200 to 600, from 250 to 600, from 300 to 600, from 350 to 600, from 400 to 600, from 450 to 600, from 500 to 600, from 200 to 500, from 250 to 500, from 300 to 500, from 350 to 500, from 400 to 500, or from 450 to 500);
POL² is a polymer comprising at least one of a polyether or a polyester, wherein the polymer has a theoretical-number-average molecular weight of from 200 to 3,000 (such as from 250 to 3,000, from 300 to 3,000, from 350 to 3,000, from 400 to 3,000, from 450 to 3,000, from 500 to 3,000, from 600 to 3,000, from 700 to 3,000, from 800 to 3,000, from 900 to 3,000, from 1,000 to 3,000, from 1,200 to 3,000, from 1,400 to 3,000, from 1,600 to 3,000, from 1,800 to 3,000, from 2,000 to 3,000, from 2,500 to 3,000, from 200 to 2,500, from 250 to 2,500, from 300 to 2,500, from 350 to 2,500, from 400 to 2,500, from 450 to 2,500, from 500 to 2,500, from 600 to 2,500, from 700 to 2,500, from 800 to 2,500, from 900 to 2,500, from 1,000 to 2,500, from 1,200 to 2,500, from 1,400 to 2,500, from 1,600 to 2,500, from 1,800 to 2,500, from 2,000 to 2,500, from 200 to 2,000, from 250 to 2,000, from 300 to 2,000, from 350 to 2,000, from 400 to 2,000, from 450 to 2,000, from 500 to 2,000, from 600 to 2,000, from 700 to 2,000, from 800 to 2,000, from 900 to 2,000, from 1,000 to 2,000, from 1,200 to 2,000, from 1,400 to 2,000, from 1,600 to 2,000, from 1,800 to 2,000, from 200 to 1,800, from 250 to 1,800, from 300 to 1,800, from 350 to 1,800, from 400 to 1,800, from 450 to 1,800, from 500 to 1,800, from 600 to 1,800, from 700 to 1,800, from 800 to 1,800, from 900 to 1,800, from 1,000 to 1,800, from 1,200 to 1,800, from 1,400 to 1,800, from 1,600 to 1,800, from 200 to 1,600, from 250 to 1,600, from 300 to 1,600, from 350 to 1,600, from 400 to 1,600, from 450 to 1,600, from 500 to 1,600, from 600 to 1,600, from 700 to 1,600, from 800 to 1,600, from 900 to 1,600, from 1,000 to 1,600, from 1,200 to 1,600, from 1,400 to 1,600, from 200 to 1,400, from 250 to 1,400, from 300 to 1,400, from 350 to 1,400, from 400 to 1,400, from 450 to 1,400, from 500 to 1,400, from 600 to 1,400, from 700 to 1,400, from 800 to 1,400, from 900 to 1,400, from 1,000 to 1,400, from 1,200 to 1,400, from 200 to 1,200, from 250 to 1,200, from 300 to 1,200, from 350 to 1,200, from 400 to 1,200, from 450 to 1,200, from 500 to 1,200, from 600 to 1,200, from 700 to 1,200, from 800 to 1,200, from 900 to 1,200, from 1,000 to 1,200, from 200 to 1,000, from 250 to 1,000, from 300 to 1,000, from 350 to 1,000, from 400 to 1,000, from 450 to 1,000, from 500 to 1,000, from 600 to 1,000, from 700 to 1,000, from 800 to 1,000, from 900 to 1,000, from 200 to 900, from 250 to 900, from 300 to 900, from 350 to 900, from 400 to 900, from 450 to 900, from 500 to 900, from 600 to 900, from 700 to 900, from 800 to 900, from 200 to 800, from 250 to 800, from 300 to 800, from 350 to 800, from 400 to 800, from 450 to 800, from 500 to 800, from 600 to 800, from 700 to 800, from 200 to 700, from 250 to 700, from 300 to 700, from 350 to 700, from 400 to 700, from 450 to 700, from 500 to 700, from 600 to 700, from 200 to 600, from 250 to 600, from 300 to 600, from 350 to 600, from 400 to 600, from 450 to 600, from 500 to 600, from 200 to 500, from 250 to 500, from 300 to 500, from 350 to 500, from 400 to 500, or from 450 to 500);
X is S, O, NH, or —O—(C═O)—;
a is an integer from 1 to 500;
b is an integer from 1 to 500;
c is 0, or an integer from 1 to 100;
d is 0, or an integer from 1 to 100; and
e is 0, or an integer from 1 to 100.

The phrase “comprising monomeric units a, b, c, d, and e according to formula I” should be understood to mean simply that the monomeric units are present (or optionally not present, as in the case of monomeric units c, d, and e) as set forth in the variable definitions provided for formula I, and also that it is possible that other monomeric units, different from monomeric units a, b, c, d, and/or e, may be included; the phrase is not intended to mean that all of the monomeric units must be present, or that other monomeric units are excluded. Further, it should be understood that the monomeric units may (perhaps likely will) be included in any order, such as a random order, rather than being present in the order shown in formula I (although it is theoretically possible that the monomeric units could be present in a block-copolymer-type structure, either in the order shown in formula I or in any other order). In practice, it may be difficult to control the placement of each monomeric unit relative to any other monomeric unit, which generally will result in a random structure; however, it is possible to control the number of units of each monomeric unit present, as would be understood by those of skill in the relevant art.

By “theoretical-number-average molecular weight”, what is meant is the average molecular weight of the subject group of bonded atoms determined by summing the molecular weight of each atom of the group based on its chemical formula.

In certain embodiments, the particulate solid is present in an amount of from 20 to 80 (such as from 25 to 80, from 30 to 80, from 35 to 80, from 40 to 80, from 45 to 80, from 50 to 80, from 55 to 80, from 60 to 80, from 65 to 80, from 70 to 80, from 75 to 80, from 20 to 75, from 25 to 75, from 30 to 75, from 35 to 75, from 40 to 75, from 45 to 75, from 50 to 75, from 55 to 75, from 60 to 75, from 65 to 75, from 70 to 75, from 20 to 70, from 25 to 70, from 30 to 70, from 35 to 70, from 40 to 70, from 45 to 70, from 50 to 70, from 55 to 70, from 60 to 70, from 65 to 70, from 20 to 65, from 25 to 65, from 30 to 65, from 35 to 65, from 40 to 65, from 45 to 65, from 50 to 65, from 55 to 65, from 60 to 65, from 20 to 60, from 25 to 60, from 30 to 60, from 35 to 60, from 40 to 60, from 45 to 60, from 50 to 60, from 55 to 60, from 20 to 55, from 25 to 55, from 30 to 55, from 35 to 55, from 40 to 55, from 45 to 55, from 50 to 55, from 20 to 50, from 25 to 50, from 30 to 50, from 35 to 50, from 40 to 50, from 45 to 50, from 20 to 45, from 25 to 45, from 30 to 45, from 35 to 45, from 40 to 45, from 20 to 40, from 25 to 40, from 30 to 40, from 35 to 40, from 20 to 35, from 25 to 35, from 30 to 35, from 20 to 30, from 25 to 30, or from 20 to 25) weight percent, based on the total weight of the thermoset composition. The particulate solid may be any solid material suitable for incorporation into a thermosetting resin, such as to create a composite material. Particulate solids of varying densities may be included in thermosetting resins, depending on the intended use of the resulting composition and/or the desired properties of the resulting composition. As such, the percent by weight of the particulate solid present in the composition may vary widely based upon both the density and the amount of particulate solid present.

In certain embodiments, the particulate solid is present in an amount of from 20 to 80 (such as from 25 to 80, from 30 to 80, from 35 to 80, from 40 to 80, from 45 to 80, from 50 to 80, from 55 to 80, from 60 to 80, from 65 to 80, from 70 to 80, from 75 to 80, from 20 to 75, from 25 to 75, from 30 to 75, from 35 to 75, from 40 to 75, from 45 to 75, from 50 to 75, from 55 to 75, from 60 to 75, from 65 to 75, from 70 to 75, from 20 to 70, from 25 to 70, from 30 to 70, from 35 to 70, from 40 to 70, from 45 to 70, from 50 to 70, from 55 to 70, from 60 to 70, from 65 to 70, from 20 to 65, from 25 to 65, from 30 to 65, from 35 to 65, from 40 to 65, from 45 to 65, from 50 to 65, from 55 to 65, from 60 to 65, from 20 to 60, from 25 to 60, from 30 to 60, from 35 to 60, from 40 to 60, from 45 to 60, from 50 to 60, from 55 to 60, from 20 to 55, from 25 to 55, from 30 to 55, from 35 to 55, from 40 to 55, from 45 to 55, from 50 to 55, from 20 to 50, from 25 to 50, from 30 to 50, from 35 to 50, from 40 to 50, from 45 to 50, from 20 to 45, from 25 to 45, from 30 to 45, from 35 to 45, from 40 to 45, from 20 to 40, from 25 to 40, from 30 to 40, from 35 to 40, from 20 to 35, from 25 to 35, from 30 to 35, from 20 to 30, from 25 to 30, or from 20 to 25) volume percent, based on the total volume of the thermoset composition.

In certain embodiments, the particulate solid comprises at least one of an extender, a reinforcing material, or a functional filler. Extenders, sometimes referred to as fillers, are generally known to be materials which are included primarily to reduce the cost of the composition without adversely affecting its properties, as they are generally less costly than other ingredients of the composition. In certain embodiments, the extender comprises at least one of calcium carbonate, talc, barium sulfate, alumina, or quartz. Suitable extenders include, but are not limited to: wollastonite (including surface-treated wollastonite); calcium sulfate (as its anhydride, dihydrate or trihydrate); calcium carbonate (including chalk); limestone, marble and synthetic, precipitated calcium carbonates, generally in the form of a ground particulate which often comprises 98+% CaCO₃ with the remainder being other inorganics such as magnesium carbonate, iron oxide, and alumino-silicates; surface-treated calcium carbonates; talc, including fibrous, modular, needle shaped, and lamellar talc; glass spheres, both hollow and solid; and kaolin, including hard, soft, calcined kaolin, and kaolin comprising various coatings known to the art to facilitate the dispersion in and compatibility with the thermoset resin; mica; feldspar and nepheline syenite; silicate spheres; flue dust; cenospheres; fillite; aluminosilicate (armospheres); natural silica sand; quartz; quartzite; perlite; Tripoli; diatomaceous earth; synthetic silica, and the like.

Functional fillers are generally known to be materials which are included primarily to provide and/or improve certain properties of the composition, such as fire/flame retardant materials and/or pigments. In certain embodiments, the functional filler comprises at least one of flame retardant materials or pigments. Suitable functional fillers may include, but are not limited to: boron-nitride powder and boron-silicate powders for obtaining cured products having low dielectric constant and low dielectric loss tangent; or silica powder (such as fused silica and/or crystalline silica), alumina, and/or magnesium oxide (or magnesia) for high temperature conductivity.

In certain embodiments, the extenders and/or functional fillers may comprise particles having an average aspect ratio less than about 5:1.

Reinforcing materials are generally known to be materials which are included primarily to increase certain physical properties of the composition, such as tensile strength. In certain embodiments, the reinforcing material comprises at least one type of fibrous material. As used herein, the term “fibrous material” is intended to mean any material of which each particle generally has a length (the longest dimension of each particle of the material, perhaps taken on average) substantially longer than its width (the shortest dimension of each particle the material, perhaps taken on average), such as a ratio of the length to the width of greater than about 5:1, perhaps taken on average. Suitable fibers may include, but are not limited to, fibers having a high tensile strength (such as greater than 500 kpsi (or 3447 MPa)), carbon or graphite fibers, glass fibers and fibers formed of silicon carbide, alumina, boron, quartz, and the like, as well as fibers formed from organic polymers, such as for example polyolefins, poly(benzothiazole), poly(benzimidazole), polyarylates, poly(benzoxazole), aromatic polyamides, polyaryl ethers and the like, and may include mixtures having two or more such fibers. The fibers may be used in the form of discontinuous or continuous tows made up of multiple filaments, as continuous unidirectional or multidirectional tapes, as chopped loose fibers, or as woven, noncrimped, or nonwoven fabrics. The woven form may be selected from plain, satin, or twill weave style. The noncrimped fabric may have a number of plies and fiber orientations.

In certain embodiments, the thermosetting resin is present in an amount of from 80 to 20 (such as from 75 to 20, from 70 to 20, from 65 to 20, from 60 to 20, from 55 to 20, from 50 to 20, from 45 to 20, from 40 to 20, from 35 to 20, from 30 to 20, from 25 to 20, from 80 to 25, from 75 to 25, from 70 to 25, from 65 to 25, from 60 to 25, from 55 to 25, from 50 to 25, from 45 to 25, from 40 to 25, from 35 to 25, from 30 to 25, from 80 to 30, from 75 to 30, from 70 to 30, from 65 to 30, from 60 to 30, from 55 to 30, from 50 to 30, from 45 to 30, from 40 to 30, from 35 to 30, from 80 to 35, from 75 to 35, from 70 to 35, from 65 to 35, from 60 to 35, from 55 to 35, from 50 to 35, from 45 to 35, from 40 to 35, from 80 to 40, from 75 to 40, from 70 to 40, from 65 to 40, from 60 to 40, from 55 to 40, from 50 to 40, from 45 to 40, from 80 to 45, from 75 to 45, from 70 to 45, from 65 to 45, from 60 to 45, from 55 to 45, from 50 to 45, from 80 to 50, from 75 to 50, from 70 to 50, from 65 to 50, from 60 to 50, from 55 to 50, from 80 to 50, from 75 to 50, from 70 to 50, from 65 to 50, from 60 to 50, from 80 to 55, from 75 to 55, from 70 to 55, from 65 to 55, from 60 to 55, from 80 to 60, from 75 to 60, from 70 to 60, from 65 to 60, from 80 to 65, from 75 to 65, from 70 to 65, from 80 to 70, from 75 to 70, or from 80 to 75) weight percent, based on the total weight of the thermoset composition.

In certain embodiments, the thermosetting resin comprises an epoxide resin, an unsaturated polyester resin, a vinyl ester resin, a polyurethane resin, or a phenolic resin. Suitable thermosetting resins include resins which undergo a chemical reaction when heated, catalysed, or subject to ultra-violet, laser light, infra-red, cationic, electron beam, or microwave radiation and become relatively infusible. Illustrative reactions in thermosetting resins include oxidation of unsaturated double bonds, reactions involving epoxy/amine, epoxy/carbonyl, epoxy/hydroxyl, reaction of epoxy with a Lewis acid or Lewis base, polyisocyanate/hydroxy, amino resin/hydroxy moieties, free radical reactions or polyacrylate, cationic polymerization of epoxy resins and vinyl ether and condensation of silanol. Examples of unsaturated resins include polyester resins made by the reaction of one or more diacids or anhydrides with one or more diols. Such resins are commonly supplied as a mixture with a reactive monomer such as styrene or vinyltoluene and are often referred to as orthophthalic resins and isophthalic resins. Further examples include resins using dicyclopentadiene (DCPD) as a co-reactant in the polyester chain. Further examples also include the reaction products of bisphenol A diglycidyl ether with unsaturated carboxylic acids such as methacrylic acid, subsequently supplied as a solution in styrene, commonly referred to as vinyl ester resins. Polymers with hydroxy functionality (such as polyols) are widely used in thermosetting systems to crosslink with amino resins or polyisocyanates. The polyols include acrylic polyols, alkyd polyols, polyester polyols, polyether polyols, and polyurethane polyols. Illustrative amino resins include melamine formaldehyde resins, benzoguanamine formaldehyde resins, urea formaldehyde resins and glycoluril formaldehyde resins. Polyisocyanates are resins with two or more isocyanate groups, including both monomeric aliphatic diisocyanates, monomeric aromatic diisocyanates and their polymers. Illustrative aliphatic diisocyanates include hexamethylene diisocyanate, isophorone diisocyanate and hydrogenated diphenylmethane diisocyanate. Illustrative aromatic isocyanates include toluene diisocyanates and biphenylmethane diisocyanates.

In certain embodiments, the coupling agent is present in an amount of from 0.5 to 5 (such as from 1 to 5, from 1.5 to 5, from 2 to 5, from 2.5 to 5, from 3 to 5, from 3.5 to 5, from 4 to 5, from 4.5 to 5, from 0.5 to 4.5, from 1 to 4.5, from 1.5 to 4.5, from 2 to 4.5, from 2.5 to 4.5, from 3 to 4.5, from 3.5 to 4.5, from 4 to 4.5, from 0.5 to 4, from 1 to 4, from 1.5 to 4, from 2 to 4, from 2.5 to 4, from 3 to 4, from 3.5 to 4, from 0.5 to 3.5, from 1 to 3.5, from 1.5 to 3.5, from 2 to 3.5, from 2.5 to 3.5, from 3 to 3.5, from 0.5 to 3, from 1 to 3, from 1.5 to 3, from 2 to 3, from 2.5 to 3, from 0.5 to 2.5, from 1 to 2.5, from 1.5 to 2.5, from 2 to 2.5, from 0.5 to 2, from 1 to 2, from 1.5 to 2, from 0.5 to 1.5, from 1 to 1.5, or from 0.5 to 1) weight percent, based on the total weight of the thermoset composition.

In certain embodiments, monomeric unit a according to formula I may be derived from radically polymerizing an aromatic or aliphatic vinyl monomer, such as an aromatic vinyl, such as styrene and/or substituted styrene, for example 4-acetoxystyrene, 4-benzhydrylstyrene, 4-benzyl oxy-3-methoxy styrene, 2-bromostyrene, 3-bromostyrene, 4-bromostyrene, 4-tert-butoxystyrene, 4-tert-butyl styrene, 2-chlorostyrene, 3-chlorostyrene, 4-chlorostyrene, 2,6-dichlorostyrene, 2,6-difluorostyrene, 3,4-dimethoxy styrene, 2,4-dimethylstyrene, 2,5-dimethyl styrene, N,N-dimethylvinylbenzylamine, 4-ethoxystyrene, 2-fluorostyrene, 3-fluorostyrene, 4-fluorostyrene, 3-methylstyrene, 4-methylstyrene, 3-nitrostyrene, 2,3,4,5,6-pentafluorostyrene, 3-(trifluoromethyl) styrene, 4-(trifluoromethyl) styrene, 2,4,6-trimethylstyrene, 4-vinylanisole, 3-vinylbenzoic acid, 4-vinylbenzoic acid, 4-vinylbenzyl chloride, 4-vinylbiphenyl, 2-vinylnaphthalene. In certain embodiments, R² may be a C₁ to C₂₀ alkyl group. In certain embodiments, R² may be a C₆ to C₁₀ aryl group.

In certain embodiments, monomeric unit b according to formula I may be derived from radically polymerizing an epoxy functional vinyl or (meth)acrylate monomer, such as (meth)acrylate, for example glycidyl methacrylate. In certain embodiments, monomeric unit b according to formula I may be derived from radically polymerizing glycidyl methacrylate or other unsaturated epoxy functional monomers, for example glycidyl methacrylate, glycidyl acrylate, glycidyl oxyalkyl (meth)acrylate, 2-[(allyloxy)methyl]oxirane, 2-(3-buten-1-yl)oxirane, 2-(2-propen-1-yl)oxirane, 2-methyl-3-(2-propen-1-yl)oxirane, 2-(2-methyl-2-propen-1-yl)oxirane, 2-(1-methyl-2-propen-1-yl)oxirane, 4,5-anhydro-1,2-dideoxy-pent-1-enitol, 2-(1,1-dimethyl-2-propen-1yl)oxirane, 2-ethyl-3-(2-propen-1-yl)oxirane, 2-(4-penten-1-yl)oxirane, α-2-propen-1-yl-2-oxiranemethanol, 2-(5-hexen-1-yl)oxirane, 2-(2-methyl)epoxy alkenes (e.g., butene, pentene, hexene), and/or 1,2-epoxy alkenes (e.g., butene, pentene, hexene).

In certain embodiments, monomeric unit c according to formula I may be derived from radically polymerizing a (meth)acrylate monomer, such as alkyl methacrylate, for example methyl methacrylate. In certain embodiments, monomeric unit c according to formula I may be derived from radically polymerizing methyl (meth)acrylate or other unsaturated alkyl monomers, for example methyl (meth)acrylate, ethyl (meth)acrylate, propyl (meth)acrylate, isopropyl (meth)acrylate, butyl (meth)acrylate, isobutyl (meth)acrylate, hexyl (meth)acrylate, 2-ethylhexyl (meth)acrylate, nonyl (meth)acrylate, lauryl (meth)acrylate, stearyl (meth)acrylate, isodecyl (meth)acrylate, and/or isobornyl (meth)acrylate.

In certain embodiments, monomeric unit d according to formula I may be derived from radically polymerizing a (meth)acrylate monomer with a polyether chain, for example poly(ethylene) glycol methyl ether (meth)acrylate, poly(propylene)glycol methacrylate, poly(ethylene)glycol vinyl ether, and/or poly(propylene)glycol vinyl ether. In certain embodiments, POL¹ is a polymer comprising at least one of a polyether or a polyester, wherein the polymer has a theoretical-number-average molecular weight of from 200 to 3,000. The polyester may be made from polymerisation of lactones with hydroxy functional (meth)acrylates, for example 2-hydroxyethyl(meth)acrylate, or hydroxy functional vinyl monomers, for example allyl alcohol, 2-allyloxyethanol, 2-allylphenol, 2-vinyloxyethanol, 2-hydroxyethyl methacrylate, hydroxypropyl methacrylate, hydroxybutyl methacrylate, and/or cinnamyl alcohol. Lactones which may be used include, but are not limited to, lactides, such as L-lactide, caprolactone, valerolactone, and alkyl substituted caprolactones, such as 7-methyl caprolactone.

In certain embodiments, monomeric unit e according to formula I may be derived from further functionalizing the monomeric unit b according to formula I, where X is a heteroatom which links POL² to the epoxy group. In certain embodiments, a hydroxy-functional polyether chain may react on to the epoxy group, for example polyethylene glycol methyl ether or polypropylene glycol methyl ether. In certain embodiments, an amino functional polyether can react on to epoxy group for example polyether amines available from Huntsman under the trade names Surfonamine® L100, L207, L300, B100, and/or B200.

In certain embodiments X is oxygen, where a mono-hydroxyl-functional polyester has been reacted on to the epoxy monomer. This mono-hydroxy-functional polyester can be synthesized by any method known to those skilled in the art by polymerization of lactones and/or lactides and/or hydroxycarboxylic acids, optionally in the presence of mono alcohols to initiate the polyester chain extension. Useful alcohols include, but are not limited to, methanol, ethanol, n-propanol, n-butanol, neopentyl alcohol, n-hexanol, n-heptanol, n-octanol, n-decanol, n-dodecanol, n-tetradecanol, n-hexadecanol, oleyl alcohol, n-octadecanol, isopropanol, isobutanol, tert-butanol, 2-ethylbutanol, 2-ethylhexanol, 3 heptanol, 3,5,5-trimethylhexanol, 3,7-dimethyloctanol, cyclohexanol, cyclopentanol, cyclopentanemethanol, cyclohexylmethanol, 4-cyclohexyl-1-butanol, 4-ethylcyclohexanol, cycloheptanol, phenol, ortho-cresol, 2-ethylphenol, 2-propylphenol, 4-ethylphenol, octyl phenol, nonylphenol, dodecylphenol, di- and tri-styrylphenols, benzyl alcohol, 2-phenylethanol, 1-naphthol, 2-naphthol, 2-phenylphenol, 4-phenylphenol, polyisobutylene phenol, sec-phenethyl alcohol, 4-ethylbenzyl alcohol, 4-butylbenzyl alcohol, 2-naphthalenemethanol, 3-phenyl-1-propanol, 4-phenyl-1-butanol, cinnamyl alcohol and 4-propoxyphenol, 2-dimethylaminoethanol, 2-diethylaminoethanol, 2-dibutylaminoethanol, 2-propen-1-ol, allyl alcohol, 4-penten-1-ol, 2-hexen-1-ol, 3-nonen-1-ol, 7-dodecen-1-ol, saturated linear alcohols commercially available under the trade name Unilin™ (available from Baker Hughes) and saturated branched alcohols such as the “Guerbet” alcohols which are commercially available under the trade name Isofol (available from Sasol GmbH) including mixtures thereof. Specific examples of commercially available Guerbet alcohols are Isofol 12, 14T, 16, 18T, 18E, 20, 24, 28, 32, 32T and 36.

In certain embodiments X is —O—(C═O)—, where a mono-acid-functional polyester has been reacted on to the epoxy monomer. This mono-acid-functional polyester can be synthesized by any method known to those skilled in the art by polymerization of lactones and/or lactides and/or hydroxycarboxylic acids, optionally in the presence of monocarboxylic acids to initiate the polyester chain extension. Specific non-limiting examples of suitable hydroxy carboxylic acids are ricinoleic acid, 12-hydroxystearic acid, 6-hydroxy caproic acid, 5-hydroxy valeric acid, 12-hydroxy dodecanoic acid, 5-hydroxy dodecanoic acid, 5-hydroxy decanoic acid, 4-hydroxy decanoic acid, 10-hydroxy undecanoic acid, lactide, glycolide, glycolic acid and/or lactic acid. Non-limiting examples of the lactones include C₁₋₄ alkyl substituted ε-caprolactone, optionally substituted C₁₋₄ alkyl δ-valerolactone and β-propiolactone. The hydroxy carboxylic acids and lactones can also include di-hydroxy compounds of the same carbon range and substitution such as 2,2-bis(hydroxymethyl) butyric acid; 2,2-bis(hydroxymethyl) propionic acid, and similar dihydroxy carboxylic acids in the specified carbon range. These would form branched polyester that would still have one carboxylic acid terminal group per polyester wherein the carboxylic acid group could be converted to an anhydride as taught in this disclosure.

In certain embodiments, the coupling agent comprises at least 90 (such as at least 91, at least 92, at least 93, at least 94, at least 95, at least 96, at least 97, at least 98, or at least 99) percent by weight monomeric units a, b, c, d, and e, according to formula I, based on the total weight of the coupling agent. In certain embodiments, the coupling agent comprises from 90 to 100 (such as from 91 to 100, from 92 to 100, from 93 to 100, from 94 to 100, from 95 to 100, from 96 to 100, from 97 to 100, from 98 to 100, from 99 to 100, from 90 to 99, from 91 to 99, from 92 to 99, from 93 to 99, from 94 to 99, from 95 to 99, from 96 to 99, from 97 to 99, from 98 to 99, from 90 to 98, from 91 to 98, from 92 to 98, from 93 to 98, from 94 to 98, from 95 to 98, from 96 to 98, from 97 to 98, from 90 to 97, from 91 to 97, from 92 to 97, from 93 to 97, from 94 to 97, from 95 to 97, from 96 to 97, from 90 to 96, from 91 to 96, from 92 to 96, from 93 to 96, from 94 to 96, from 95 to 96, from 90 to 95, from 91 to 95, from 92 to 95, from 93 to 95, from 94 to 95, from 90 to 94, from 91 to 94, from 92 to 94, from 93 to 94, from 90 to 93, from 91 to 93, from 92 to 93, from 90 to 92, from 91 to 92, or from 90 to 91) percent by weight monomeric units a, b, c, d, and e, according to formula I, based on the total weight of the coupling agent.

In certain embodiments, the coupling agent comprises at least 70 (such as at least 75, at least 80, at least 85, at least 90, or at least 95) percent by weight monomeric units a and b, according to formula I, based on the total weight of the coupling agent. In certain embodiments, the coupling agent comprises from 70 to 95 (such as from 75 to 95, from 80 to 95, from 85 to 95, from 90 to 95, from 70 to 90, from 75 to 90, from 80 to 90, from 85 to 90, from 70 to 85, from 75 to 85, from 80 to 85, from 70 to 80, from 75 to 80, or from 70 to 75) percent by weight monomeric units a and b, according to formula I, based on the total weight of the coupling agent.

In certain embodiments, the coupling agent comprises no more than 30 (such as no more than 25, no more than 20, no more than 15, no more than 10, or no more than 5) percent by weight monomeric units c, d, and e, according to formula I, based on the total weight of the coupling agent. In certain embodiments, the coupling agent comprises from 5 to 30 (such as from 10 to 30, from 15 to 30, from 20 to 30, from 25 to 30, from 5 to 25, from 10 to 25, from 15 to 25, from 20 to 25, from 5 to 20, from 10 to 20, from 15 to 20, from 5 to 15, from 10 to 15, or from 5 to 10) percent by weight monomeric units c, d, and e, according to formula I, based on the total weight of the coupling agent.

In certain embodiments, the coupling agent comprises at least 50 (such as at least 55, at least 60, at least 65, at least 70, at least 75, or at least 80) percent by weight monomeric units a, according to formula I, based on the total weight of the coupling agent. In certain embodiments, the coupling agent comprises from 50 to 80 (such as from 55 to 80, from 60 to 80, from 65 to 80, from 70 to 80, from 75 to 80, from 50 to 75, from 55 to 75, from 60 to 75, from 65 to 75, from 70 to 75, from 50 to 70, from 55 to 70, from 60 to 70, from 65 to 70, from 50 to 65, from 55 to 65, from 60 to 65, from 50 to 60, from 55 to 60, or from 50 to 55) percent by weight monomeric units a, according to formula I, based on the total weight of the coupling agent.

In certain embodiments, the coupling agent comprises no more than 40 (such as no more than 35, no more than 30, no more than 25, no more than 20, no more than 15, no more than 10, or no more than 5) percent by weight monomeric units b, according to formula I, based on the total weight of the coupling agent. In certain embodiments, the coupling agent comprises from 5 to 40 (such as from 10 to 40, from 15 to 40, from 20 to 40, from 25 to 40, from 30 to 40, from 35 to 40, from 5 to 35, from 10 to 35, from 15 to 35, from 20 to 35, from 25 to 35, from 30 to 35, from 5 to 30, from 10 to 30, from 15 to 30, from 20 to 30, from 25 to 30, from 5 to 25, from 10 to 25, from 15 to 25, from 20 to 25, from 5 to 20, from 10 to 20, from 15 to 20, from 5 to 15, from 10 to 15, or from 5 to 10) percent by weight monomeric units b, according to formula I, based on the total weight of the coupling agent.

In certain embodiments, a is an integer from 5 to 500, such as from 10 to 500, from 15 to 500, from 20 to 500, from 25 to 500, from 50 to 500, from 75 to 500, from 100 to 500, from 150 to 500, from 200 to 500, from 250 to 500, from 300 to 500, from 350 to 500, from 400 to 500, from 450 to 500, from 1 to 450, from 5 to 450, from 10 to 450, from 15 to 450, from 20 to 450, from 25 to 450, from 50 to 450, from 75 to 450, from 100 to 450, from 150 to 450, from 200 to 450, from 250 to 450, from 300 to 450, from 350 to 450, from 400 to 450, from 1 to 400, from 5 to 400, from 10 to 400, from 15 to 400, from 20 to 400, from 25 to 400, from 50 to 400, from 75 to 400, from 100 to 400, from 150 to 400, from 200 to 400, from 250 to 400, from 300 to 400, from 350 to 400, from 1 to 250, from 5 to 350, from 10 to 350, from 15 to 350, from 20 to 350, from 25 to 350, from 50 to 350, from 75 to 350, from 100 to 350, from 150 to 350, from 200 to 350, from 250 to 350, from 300 to 350, from 1 to 300, from 5 to 300, from 10 to 300, from 15 to 300, from 20 to 300, from 25 to 300, from 50 to 300, from 75 to 300, from 100 to 300, from 150 to 300, from 200 to 300, from 250 to 300, from 1 to 250, from 5 to 250, from 10 to 250, from 15 to 250, from 20 to 250, from 25 to 250, from 50 to 250, from 75 to 250, from 100 to 250, from 150 to 250, from 200 to 250, from 1 to 200, from 5 to 200, from 10 to 200, from 15 to 200, from 20 to 200, from 25 to 200, from 50 to 200, from 75 to 200, from 100 to 200, from 150 to 200, from 1 to 150, from 5 to 150, from 10 to 150, from 15 to 150, from 20 to 150, from 25 to 150, from 50 to 150, from 75 to 150, from 100 to 150, from 1 to 100, from 5 to 100, from 10 to 100, from 15 to 100, from 20 to 100, from 25 to 100, from 50 to 100, from 75 to 100, from 1 to 75, from 5 to 75, from 10 to 75, from 15 to 75, from 20 to 75, from 25 to 75, from 50 to 75, from 1 to 50, from 5 to 50, from 10 to 50, from 15 to 50, from 20 to 50, from 25 to 50, from 1 to 25, from 5 to 25, from 10 to 25, from 15 to 25, from 20 to 25, from 1 to 20, from 5 to 20, from 10 to 20, from 15 to 20, from 1 to 15, from 5 to 15, from 10 to 15, from 1 to 10, from 5 to 10, or from 1 to 5.

In certain embodiments, b is an integer from 5 to 500, such as from 10 to 500, from 15 to 500, from 20 to 500, from 25 to 500, from 50 to 500, from 75 to 500, from 100 to 500, from 150 to 500, from 200 to 500, from 250 to 500, from 300 to 500, from 350 to 500, from 400 to 500, from 450 to 500, from 1 to 450, from 5 to 450, from 10 to 450, from 15 to 450, from 20 to 450, from 25 to 450, from 50 to 450, from 75 to 450, from 100 to 450, from 150 to 450, from 200 to 450, from 250 to 450, from 300 to 450, from 350 to 450, from 400 to 450, from 1 to 400, from 5 to 400, from 10 to 400, from 15 to 400, from 20 to 400, from 25 to 400, from 50 to 400, from 75 to 400, from 100 to 400, from 150 to 400, from 200 to 400, from 250 to 400, from 300 to 400, from 350 to 400, from 1 to 250, from 5 to 350, from 10 to 350, from 15 to 350, from 20 to 350, from 25 to 350, from 50 to 350, from 75 to 350, from 100 to 350, from 150 to 350, from 200 to 350, from 250 to 350, from 300 to 350, from 1 to 300, from 5 to 300, from 10 to 300, from 15 to 300, from 20 to 300, from 25 to 300, from 50 to 300, from 75 to 300, from 100 to 300, from 150 to 300, from 200 to 300, from 250 to 300, from 1 to 250, from 5 to 250, from 10 to 250, from 15 to 250, from 20 to 250, from 25 to 250, from 50 to 250, from 75 to 250, from 100 to 250, from 150 to 250, from 200 to 250, from 1 to 200, from 5 to 200, from 10 to 200, from 15 to 200, from 20 to 200, from 25 to 200, from 50 to 200, from 75 to 200, from 100 to 200, from 150 to 200, from 1 to 150, from 5 to 150, from 10 to 150, from 15 to 150, from 20 to 150, from 25 to 150, from 50 to 150, from 75 to 150, from 100 to 150, from 1 to 100, from 5 to 100, from 10 to 100, from 15 to 100, from 20 to 100, from 25 to 100, from 50 to 100, from 75 to 100, from 1 to 75, from 5 to 75, from 10 to 75, from 15 to 75, from 20 to 75, from 25 to 75, from 50 to 75, from 1 to 50, from 5 to 50, from 10 to 50, from 15 to 50, from 20 to 50, from 25 to 50, from 1 to 25, from 5 to 25, from 10 to 25, from 15 to 25, from 20 to 25, from 1 to 20, from 5 to 20, from 10 to 20, from 15 to 20, from 1 to 15, from 5 to 15, from 10 to 15, from 1 to 10, from 5 to 10, or from 1 to 5.

In certain embodiments, the ratio of a to b is from 1:1 to 10:1, from 1:1 to 9:1, from 1:1 to 8:1, from 1:1 to 7:1, from 1:1 to 6:1, from 1:1 to 5:1, from 1:1 to 4:1, from 1:1 to 3:1, from 1:1 to 2:1, from 2:1 to 10:1, from 2:1 to 9:1, from 2:1 to 8:1, from 2:1 to 7:1, from 2:1 to 6:1, from 2:1 to 5:1, from 2:1 to 4:1, from 2:1 to 3:1, from 3:1 to 10:1, from 3:1 to 9:1, from 3:1 to 8:1, from 3:1 to 7:1, from 3:1 to 6:1, from 3:1 to 5:1, from 3:1 to 4:1, from 4:1 to 10:1, from 4:1 to 9:1, from 4:1 to 8:1, from 4:1 to 7:1, from 4:1 to 6:1, from 4:1 to 5:1, from 5:1 to 10:1, from 5:1 to 9:1, from 5:1 to 8:1, from 5:1 to 7:1, from 5:1 to 6:1, from 6:1 to 10:1, from 6:1 to 9:1, from 6:1 to 8:1, from 6:1 to 7:1, from 7:1 to 10:1, from 7:1 to 9:1, from 7:1 to 8:1, from 8:1 to 10:1, from 8:1 to 9:1, or from 9:1 to 10:1.

In certain embodiments, c is an integer from 1 to 100, from 5 to 100, from 10 to 100, from 15 to 100, from 20 to 100, from 30 to 100, from 40 to 100, from 50 to 100, from 60 to 100, from 70 to 100, from 80 to 100, from 90 to 100, from 1 to 90, from 5 to 90, from 10 to 90, from 15 to 90, from 20 to 90, from 30 to 90, from 40 to 90, from 50 to 90, from 60 to 90, from 70 to 90, from 80 to 90, from 1 to 80, from 5 to 80, from 10 to 80, from 15 to 80, from 20 to 80, from 30 to 80, from 40 to 80, from 50 to 80, from 60 to 80, from 70 to 80, from 1 to 70, from 5 to 70, from 10 to 70, from 15 to 70, from 20 to 70, from 30 to 70, from 40 to 70, from 50 to 70, from 60 to 70, from 1 to 60, from 5 to 60, from 10 to 60, from 15 to 60, from 20 to 60, from 30 to 60, from 40 to 60, from 50 to 60, from 1 to 50, from 5 to 50, from 10 to 50, from 15 to 50, from 20 to 50, from 30 to 50, from 40 to 50, from 1 to 40, from 5 to 40, from 10 to 40, from 15 to 40, from 20 to 40, from 30 to 40, from 1 to 30, from 5 to 30, from 10 to 30, from 15 to 30, from 20 to 30, from 1 to 20, from 5 to 20, from 10 to 20, from 15 to 20, from 1 to 15, from 5 to 15, from 10 to 15, from 1 to 10, from 5 to 10, or from 1 to 5.

In certain embodiments, d is an integer from 1 to 100, from 5 to 100, from 10 to 100, from 15 to 100, from 20 to 100, from 30 to 100, from 40 to 100, from 50 to 100, from 60 to 100, from 70 to 100, from 80 to 100, from 90 to 100, from 1 to 90, from 5 to 90, from 10 to 90, from 15 to 90, from 20 to 90, from 30 to 90, from 40 to 90, from 50 to 90, from 60 to 90, from 70 to 90, from 80 to 90, from 1 to 80, from 5 to 80, from 10 to 80, from 15 to 80, from 20 to 80, from 30 to 80, from 40 to 80, from 50 to 80, from 60 to 80, from 70 to 80, from 1 to 70, from 5 to 70, from 10 to 70, from 15 to 70, from 20 to 70, from 30 to 70, from 40 to 70, from 50 to 70, from 60 to 70, from 1 to 60, from 5 to 60, from 10 to 60, from 15 to 60, from 20 to 60, from 30 to 60, from 40 to 60, from 50 to 60, from 1 to 50, from 5 to 50, from 10 to 50, from 15 to 50, from 20 to 50, from 30 to 50, from 40 to 50, from 1 to 40, from 5 to 40, from 10 to 40, from 15 to 40, from 20 to 40, from 30 to 40, from 1 to 30, from 5 to 30, from 10 to 30, from 15 to 30, from 20 to 30, from 1 to 20, from 5 to 20, from 10 to 20, from 15 to 20, from 1 to 15, from 5 to 15, from 10 to 15, from 1 to 10, from 5 to 10, or from 1 to 5.

In certain embodiments, e is an integer from 1 to 100, from 5 to 100, from 10 to 100, from 15 to 100, from 20 to 100, from 30 to 100, from 40 to 100, from 50 to 100, from 60 to 100, from 70 to 100, from 80 to 100, from 90 to 100, from 1 to 90, from 5 to 90, from 10 to 90, from 15 to 90, from 20 to 90, from 30 to 90, from 40 to 90, from 50 to 90, from 60 to 90, from 70 to 90, from 80 to 90, from 1 to 80, from 5 to 80, from 10 to 80, from 15 to 80, from 20 to 80, from 30 to 80, from 40 to 80, from 50 to 80, from 60 to 80, from 70 to 80, from 1 to 70, from 5 to 70, from 10 to 70, from 15 to 70, from 20 to 70, from 30 to 70, from 40 to 70, from 50 to 70, from 60 to 70, from 1 to 60, from 5 to 60, from 10 to 60, from 15 to 60, from 20 to 60, from 30 to 60, from 40 to 60, from 50 to 60, from 1 to 50, from 5 to 50, from 10 to 50, from 15 to 50, from 20 to 50, from 30 to 50, from 40 to 50, from 1 to 40, from 5 to 40, from 10 to 40, from 15 to 40, from 20 to 40, from 30 to 40, from 1 to 30, from 5 to 30, from 10 to 30, from 15 to 30, from 20 to 30, from 1 to 20, from 5 to 20, from 10 to 20, from 15 to 20, from 1 to 15, from 5 to 15, from 10 to 15, from 1 to 10, from 5 to 10, or from 1 to 5.

In certain embodiments, if d is greater than 0, e is 0, and if e is greater than 0, d is 0. In certain embodiments: (i) d is 0, or an integer from 1 to 100 (such as from 5 to 100, from 10 to 100, from 15 to 100, from 20 to 100, from 30 to 100, from 40 to 100, from 50 to 100, from 60 to 100, from 70 to 100, from 80 to 100, from 90 to 100, from 1 to 90, from 5 to 90, from 10 to 90, from 15 to 90, from 20 to 90, from 30 to 90, from 40 to 90, from 50 to 90, from 60 to 90, from 70 to 90, from 80 to 90, from 1 to 80, from 5 to 80, from 10 to 80, from 15 to 80, from 20 to 80, from 30 to 80, from 40 to 80, from 50 to 80, from 60 to 80, from 70 to 80, from 1 to 70, from 5 to 70, from 10 to 70, from 15 to 70, from 20 to 70, from 30 to 70, from 40 to 70, from 50 to 70, from 60 to 70, from 1 to 60, from 5 to 60, from 10 to 60, from 15 to 60, from 20 to 60, from 30 to 60, from 40 to 60, from 50 to 60, from 1 to 50, from 5 to 50, from 10 to 50, from 15 to 50, from 20 to 50, from 30 to 50, from 40 to 50, from 1 to 40, from 5 to 40, from 10 to 40, from 15 to 40, from 20 to 40, from 30 to 40, from 1 to 30, from 5 to 30, from 10 to 30, from 15 to 30, from 20 to 30, from 1 to 20, from 5 to 20, from 10 to 20, from 15 to 20, from 1 to 15, from 5 to 15, from 10 to 15, from 1 to 10, from 5 to 10, or from 1 to 5); and (ii) e is 0, or an integer from 1 to 100 (such as from 5 to 100, from 10 to 100, from 15 to 100, from 20 to 100, from 30 to 100, from 40 to 100, from 50 to 100, from 60 to 100, from 70 to 100, from 80 to 100, from 90 to 100, from 1 to 90, from 5 to 90, from 10 to 90, from 15 to 90, from 20 to 90, from 30 to 90, from 40 to 90, from 50 to 90, from 60 to 90, from 70 to 90, from 80 to 90, from 1 to 80, from 5 to 80, from 10 to 80, from 15 to 80, from 20 to 80, from 30 to 80, from 40 to 80, from 50 to 80, from 60 to 80, from 70 to 80, from 1 to 70, from 5 to 70, from 10 to 70, from 15 to 70, from 20 to 70, from 30 to 70, from 40 to 70, from 50 to 70, from 60 to 70, from 1 to 60, from 5 to 60, from 10 to 60, from 15 to 60, from 20 to 60, from 30 to 60, from 40 to 60, from 50 to 60, from 1 to 50, from 5 to 50, from 10 to 50, from 15 to 50, from 20 to 50, from 30 to 50, from 40 to 50, from 1 to 40, from 5 to 40, from 10 to 40, from 15 to 40, from 20 to 40, from 30 to 40, from 1 to 30, from 5 to 30, from 10 to 30, from 15 to 30, from 20 to 30, from 1 to 20, from 5 to 20, from 10 to 20, from 15 to 20, from 1 to 15, from 5 to 15, from 10 to 15, from 1 to 10, from 5 to 10, or from 1 to 5); with the proviso that if d is greater than 0, e is 0, and if e is greater than 0, d is 0.

In certain embodiments, the coupling agent comprises up to 10 (such as up to 9, up to 8, up to 7, up to 6, up to 5, up to 4, up to 3, up to 2, or up to 1) percent by weight other monomeric units, different from monomeric units a, b, c, d, and e according to formula I. In certain embodiments, the coupling agent comprises from greater than 0 to 10 (such as from greater than 0 to 9, from greater than 0 to 7, from greater than 0 to 6, from greater than 0 to 5, from greater than 0 to 4, from greater than 0 to 3, from greater than 0 to 2, from greater than 0 to 1, from 1 to 10, from 1 to 9, from 1 to 8, from 1 to 7, from 1 to 6, from 1 to 5, from 1 to 4, from 1 to 3, from 1 to 2, from 2 to 10, from 2 to 9, from 2 to 8, from 2 to 7, from 2 to 6, from 2 to 5, from 2 to 4, from 2 to 3, from 3 to 10, from 3 to 9, from 3 to 8, from 3 to 7, from 3 to 6, from 3 to 5, from 3 to 4, from 4 to 10, from 4 to 9, from 4 to 8, from 4 to 7, from 4 to 6, from 4 to 5, from 5 to 10, from 5 to 9, from 5 to 8, from 5 to 7, from 5 to 6, from 6 to 10, from 6 to 9, from 6 to 8, from 6 to 7, from 7 to 10, from 7 to 9, from 7 to 8, from 8 to 10, from 8 to 9, or from 9 to 10) percent by weight other monomeric units, different from monomeric units a, b, c, d, and e according to formula I. In certain embodiments, the coupling agents is substantially free of, or free of, other monomeric units, different from monomeric units a, b, c, d, and e according to formula I. In this context, “substantially free of” means that the other monomeric units are not intentionally added or created, but that they may be present by inclusion of impurities in reactants and/or by creation of unintended reaction products. In certain embodiments, the other monomeric units are vinyl-functional monomeric units.

Also provided is a method of manufacturing the thermoset composition(s) described herein, comprising dissolving the coupling agent into the thermoset resin with or without solvent, then adding the particulate solid and other additives. The other additives may include at least one of dispersants, defoamers, internal release agents, accelerators, etc.

Also provided is a method of manufacturing the thermoset composition(s) described herein, comprising dispersing the coupling agent as a dry solid into the thermosetting resin, then adding the particulate solid and other additives. The other additives may include at least one of dispersants, defoamers, internal release agents, accelerators, etc.

Also provided is a method of imparting high/improved tensile strength to the thermoset composition(s) described herein, comprising dispersing the particulate solid into the thermosetting resin in the presence of the coupling agent.

Also provided is a method of imparting fire retardancy to the thermoset composition(s) described herein, comprising dispersing the particulate solid (which imparts fire retardancy) into the thermosetting resin in the presence of the coupling agent.

Also provided is a method of light-weighting the thermoset composition(s) described herein, comprising dispersing a hollow particle (glass sphere) and filler (as the particulate solid) into the thermosetting resin in the presence of the coupling agent.

Also provided is a method of manufacturing the thermoset composition(s) described herein, comprising treating the particulate solid with the coupling agent to create a treated particulate solid, then adding the treated particulate solid to the thermosetting resin. For example, fibrous material may be pre-treated with a sizing agent that also acts as the coupling agent.

The subject matter disclosed herein may be better understood with reference to the following examples, which are set forth merely to further illustrate the subject matter disclosed herein. The illustrative examples should not be construed as limiting the subject matter in any manner.

All monomers and solvents were sparged with nitrogen for 30 minutes before polymerization.

Example 1: Styrene (46.6 parts), glycidyl methacrylate (15.9 parts), and butyl 3-mercaptopropionate (0.14 parts) were dissolved in butyl acetate (45.7 parts) and heated to 65° C. under nitrogen. 2,2′-azobis(2,4-dimethylvaleronitrile) (V65 ex Fujifilm®, 1.35 parts) were then added to reaction mixture over 81 hours. During the first 3 hours, a further 17 parts of butyl acetate were added. A viscous, colorless liquid was obtained, having Mn of 17670 and Mw of 52550 as determined by GPC in THF using polystyrene standards, and solids content was 65.6%.

Example 2: Styrene (46.6 parts) and glycidyl methacrylate (15.9 parts) were dissolved in butyl acetate (44.5 parts) and heated to 80° C. under nitrogen. 2,2′-azobis(isobutyronitrile) (AIBN, 2 parts) was then added to reaction mixture over 50 hours. During the first 3 hours, a further 20 parts of butyl acetate was added. A viscous, colorless liquid was obtained, having Mn of 11000 and Mw of 37540 as determined by GPC in THF using polystyrene standards, and solids content was 60.3%.

Example 3: Styrene (46.6 parts), glycidyl methacrylate (15.9 parts), and bis[(difluroboryl)dimethylglyoximato]cobalt (II) (CoBF, 0.046 parts) were dissolved in butyl acetate (54.02 parts) and heated to 80° C. under nitrogen. 2,2′-azobis(isobutyronitrile) (AIBN, 1.47 parts) was then added to reaction mixture over 50 hours. During the first 2 hours, a further 10 parts or butyl acetate was added. An amber liquid is obtained, having Mn of 570 and Mw of 1570 as determined by GPC in THF using polystyrene standards, and solids content was 55.4%.

Example 4 was a styrene and glycidyl methacrylate random copolymer having a number average molecular weight of 50,000 g/mol, with 20 mol % glycidyl methacrylate and 80 mol % styrene.

Example 5 was a styrene, glycidyl methacrylate, and methyl methacrylate random copolymer having a number average molecular weight of 80,000 g/mol, with 15 mol % glycidyl methacrylate and 85 mol % styrene/methyl methacrylate.

Examples 4 and 5 were incorporated into dispersions of calcium carbonate (Imercarb™ 2 L ex Imerys) in a liquid epoxy resin (Epikote™ 827 ex Hexion) by mixing for a total of time of 10 mins on a planetary centrifugal mixer at 2,000 rpm allowing the sample to cool to room temperature every 2 mins. The formulations include a dicyandiamide curing agent (Amicure® CG1400F ex Evonik), a polyether amine (Jeffamine® D-230 ex Huntsman), and an imidazole curing accelerator (Curezol® 2MZ-Azine ex Evonik). The resulting compound was compressed onto a PTFE mould using a hotpress at 130° C. for 30 minutes, then conditioned for two days at 60° C. in an oven. Examples 6 through 8 included the number of parts of each component shown in Table 1, below. The tensile strength of each of Examples 6 through 8 of the cured compositions were measured by an Instron® 3367 tensile tester (5 kN load cell at 1 mm/min), and were reported in MPa.

TABLE 1

| | Ex. 6 | Ex. 7 | Ex. 8 |
|---|---|---|---|
| Epoxy resin | 50 | 50 | 50 |
| Curing agent | 2.8 | 2.8 | 2.8 |
| Polyether amine | 2.5 | 2.5 | 2.5 |
| Curing accelerator | 0.8 | 0.8 | 0.8 |
| Example 4 | 0 | 9.1 | 0 |
| Example 5 | 0 | 0 | 9.1 |
| Calcium carbonate | 125 | 125 | 125 |
| Tensile strength | 28.0 | 37.8 | 39.1 |

Example 9: Styrene (24.55 parts), glycidyl methacrylate (11.17 parts), polyethelene glycol methyl ether methacrylate (MW=500, 39.28 parts) and butyl 3-mercaptopropionate (0.19 parts) were dissolved in butyl acetate (55.83 parts). The mixture was heated to 90° C. under nitrogen, and benzoyl peroxide (Luperox® A75, 0.63 parts) and butyl acetate (20 parts) were added over 4 hours. The reaction was then stirred at 90° C. for 18 hours. Benzoyl peroxide (Luperox® A75, 0.25 parts) was added and the reaction was stirred at 90° C. for 5.5 hours. Benzoyl peroxide (Luperox® A75, 0.25 parts) was added and the reaction was stirred at 90° C. for 18.5 hours. A viscous, colourless liquid was obtained, having Mn=37665 and Mw=180802 as determined by GPC in THF using polystyrene standards.

Intermediate A: Lauric acid (50.99 parts), ¿-caprolactone (399.51 parts), 8-valerolactone (71.34 parts) and zirconium IV butoxide (80% in 1-butanol, 2.28 parts) were heated to 160° C. under nitrogen for 15 minutes, then heated to 172° C. for 5 hours. An amber liquid was obtained which solidifies on cooling with acid value=24.0 mg KOH g⁻¹.

Example 10: Example 2 (40 parts), Intermediate A (17.27 parts) and tetrabutylammonium iodide (0.17 parts) were stirred under nitrogen for 24 hours. A very viscous liquid was obtained having Mn=13583 and Mw=99612 as determined by GPC in THF using polystyrene standards.

Example 11: Styrene (24.29 parts), glycidyl methacrylate (24.87 parts), methyl methacrylate (5.84 parts) and butyl 3-mercaptopropionate (0.38 parts) were dissolved in toluene (36.02 parts). The mixture was heated to 80° C. under nitrogen, and azobisisobutyronitrile (AIBN, 0.64 parts) and toluene (20 parts) were added over 4 hours. The reaction was then stirred at 80° C. for 18 hours. Azobisisobutyonitrile (AIBN, 0.32 parts) was added and the reaction was stirred at 80° C. for 17 hours. Azobisisobutyonitrile (AIBN, 0.32 parts) and toluene (2.5 parts) were added and the reaction was stirred at 85° C. for 4 hours. A viscous, colourless liquid was obtained, having Mn=9881 and Mw=20888 as determined by GPC in THF using polystyrene standards.

Example 12: Styrene (18.94 parts), glycidyl methacrylate (12.93 parts), lauryl methacrylate (23.13 parts) and butyl 3-mercaptopropionate (0.18 parts) were dissolved in toluene (45.12 parts). The mixture was heated to 90° C. under nitrogen, and benzoyl peroxide (Luperox® A75, 0.59 parts) and toluene (10 parts) were added over 4 hours. The reaction was then stirred at 90° C. for 18 hours. Benzoyl peroxide (Luperox® A75, 0.6 parts) and toluene (5 parts) were added and the reaction was stirred at 90° C. for 6.5 hours. Benzoyl peroxide (Luperox® A75, 0.3 parts) and toluene (5 parts) were added and the reaction was stirred at 85° C. for 6 hours. A viscous, colourless liquid was obtained, having Mn=20280 and Mw=55755 as determined by GPC in THF using polystyrene standards.

Example 13: Styrene (46.60 parts), glycidyl methacrylate (15.90 parts) and butyl 3-mercaptopropionate (0.27 parts) were dissolved in butyl acetate (52.84 parts). The mixture was heated to 80° C. under nitrogen, and azobisisobutyronitrile (AIBN, 0.07 parts) and butyl acetate (10 parts) were added over 2 hours. The reaction was then stirred at 80° C. for 21 hours. Azobisisobutyonitrile (AIBN, 0.21 parts) was added over 7 hours and the reaction was stirred at 80° C. for 18.5 hours. Azobisisobutyonitrile (AIBN, 0.07 parts) was added and the reaction was stirred at 80° C. for 6.5 hours. Azobisisobutyonitrile (AIBN, 0.07 parts) was added and the reaction was stirred at 80° C. for 5 hours. A viscous, colourless liquid was obtained, having Mn=23059 and Mw=62994 as determined by GPC in THF using polystyrene standards.

The following testing was carried out to determine the suitability of the examples described above for various applications where fiber- and/or filler-reinforced thermoset plastic may be used. Suitable tests (or modifications thereof) for assessing mechanical properties in composite articles are numerous, and are summarized non-exhaustively in ASTM D4762-18; it is contemplated that any of these tests may be used to ascertain the effectiveness of the present subject matter in particular materials and/or for particular uses of the resulting materials. One illustrative test which may be applied to the study of thermoset materials is described in Interface strength in glass fibre-polypropylene measured using the fibre pull-out and microbond methods. L. Yang & J. L. Thomason, 2010, Composites Part A: Applied Science and Manufacturing, Vol 41, issue 9 p 1077-1083. Any such test may be useful in demonstratinv the benefits of the subject matter described herein (via the examples described above) when used appropriately by a person of ordinary skill in the art. The benefits observed herein may thus show that other benefits may be likely, which may be demonstrated in appropriately-chosen, higher-order, static or dynamic, mechanical tests.

Examples 1, 2, 3, 4, 5, 9, 11 and 13 were incorporated into dispersions of calcium carbonate (“CC”, Carbital™ 110 s ex Imerys) or aluminium trihydroxide (“AT”, Martinal™ OL104 ex Huber) and milled carbon fibre (“MCF”, Carbiso™ MF ex ELG Carbon Fibre) or milled glass fibre (“MGF”, 1320K ex Owens Corning) or cut carbon fibre (“CCF”, Carbiso™ C IMP56P-03-10 ex ELG Carbon Fibre) in a liquid epoxy resin (“ER”, Epikote™ 827 ex Hexion) by mixing for a total of time of 6-10 mins on a planetary centrifugal mixer at 2,000 rpm allowing the sample to cool to room temperature every 2 mins. The formulations include a dicyandiamide curing agent (“DCA”, Amicure® CG1400F ex Evonik) and an imidazole curing accelerator (“ICA”, Curezol® 2MZ-Azine ex Evonik). Table 2 details the % by weight of each component in the tested formulations for examples 14, 15, 16, 17, 18, 19, 20 and 21, 22, 23.

TABLE 2

| | Example No. | | | | | | | | | |
|---|---|---|---|---|---|---|---|---|---|---|
| | 14 | 15 | 16 | 17 | 18 | 19 | 20 | 21 | 22 | 23 |
| Ex. 1 | | 1.5 | | | | | | | | |
| Ex. 2 | | | 1.6 | | | | | | | |
| Ex. 3 | | | | 1.6 | | | | | | |
| Ex. 13 | | | | | 1.1 | | | | | |
| Ex. 11 | | | | | | 1.1 | | | | |
| Ex. 9 | | | | | | | 1.4 | | | |
| Ex. 4 | | | | | | | | | 4.8 | |
| Ex. 5 | | | | | | | | | | 4.8 |
| ER | 41.5 | 40.9 | 40.8 | 40.8 | 36.9 | 36.9 | 36.8 | 43.4 | 41.4 | 41.4 |
| DCA | 4.3 | 4.2 | 4.2 | 4.2 | 3.9 | 3.9 | 3.9 | 2.4 | 2.3 | 2.3 |
| ICA | 2.8 | 2.7 | 2.7 | 2.7 | 2.5 | 2.5 | 2.5 | 0.7 | 0.7 | 0.7 |
| AT | | | | | 37.1 | 37.1 | 37.0 | | | |
| CC | 41.1 | 40.4 | 40.4 | 40.4 | | | | 43.4 | 41.4 | 41.4 |
| MCF | 10.4 | 10.2 | 10.2 | 10.2 | | | | | | |
| CCF | | | | | | | | 10.0 | 9.5 | 9.5 |
| MGF | | | | | 18.5 | 18.5 | 18.4 | | | |

Examples 14, 15, 16, 17, 21, 22 & 23 are representative of a typical formulation suitable for compression molding of CFRP engineered parts. Whereas examples 18, 19 & 20 are representative of a fire retardant formulation typically used for GFRP compression moulded electrical fittings.

Testing on examples 14, 15, 16, 17, 18, 19, 20, 24, 25, 26, 27, 28 and 29 was undertaken with milled fibers. In general, the formulations described were tested in a single frequency, oscillatory ‘through cure’ experiment of the type described by Tianhong T. Chen et al. (Characterising thermoset curing using rheology; SAMPE Conference proceedings 2019, Society for the advancement of Material and Process Engineering). Using additional guidance from ASTM D4065 20 Standard Practice for Plastics: Dynamic Mechanical Properties: Determination and report Procedures.

A DHR-1 rheometer (TAInstruments) fitted with 25 mm disposable aluminium parallel plates was used in conjunction with an ETC accessory. All test involved subjecting a sample of uncured formulation of set volume, determined by the initial geometry gap; to torsional oscillations at a frequency of 1 Hz through a temperature profile that cured the formulation of interest and was applicable to the application of interest. Active controls were used in both strain and axial force during the test to enable monitoring of the curing process whilst staying within the linear viscoelastic limit of the material but maintaining a good signal to noise ratio. Axial force adjustment was used throughout the runs actively controlling axial force to 0.0±0.1 N in compression mode and auto strain adjustment was used as described in the referenced procedure.

Measurements derived from individual experiments were calculated from analysis carried out in the instrument supported Trios software. The Onset ‘gel’ temperature of cure was calculated from the storage modulus curve with respect to temperature (T vs Log(G′)), the endset time of cure was calculated from the storage modulus with respect to time (T vs Log(G′)). The storage modulus in the isothermal post cure plateau region of the experiment, could be taken directly by averaging over the chosen time range data points (^{a}) or by correcting to account for differences in the gap between experiments for different samples through regression correlation in this region (^{b}), to adhere to the principles of equivalent sample dimensions dictated in ASTM D4065 20 but applied in this experimental context of torsion between parallel plates. The measurement derived from the through cure experiments were used to screen the exampled coupling agent for their suitability in the exemplified formulation and inferred applications.

In the through cure experiments carried out on examples 14, 15, 16, 17, 18, 19, 20, 21, 22 and 23, a temperature ramp from 25-135° C. at 5° C./min. Holding at 135° C. for 10 mins to continue measurement post sample cure. Initial gap size was 1000 μm with a trim offset of 50 μm, giving a minimum sample volume at test start of 0.49087 mL. A gap temperature compensation—expansion coefficient of 2.7398 μm/° C., compliance of 2.02 mrad/N·m, stress constant 325949 Pa/N·m, strain constant 12.5 1/rad and normal stress constant 4074.37 Pa/N. However, geometry inertia (“GI”, μN·m·s²) and friction (“FR”, μN·m/(rad/s)) was calibrated for each run. Variable run parameters for examples 14, 15, 16, 17, 18, 19, 20, 21, 22 and 23 are summarised as follows in Table 3.

TABLE 3

| Ex. No. | Additive | GI | FR |
|---|---|---|---|
| 14 | — | 2.34254 | 0.278571 |
| 15 | Ex. 1 | 2.34857 | 0.27846 |
| 16 | Ex. 2 | 2.34653 | 0.27916 |
| 17 | Ex. 3 | 2.34957 | 0.27972 |
| 18 | Ex. 13 | 2.39056 | 0.27499 |
| 19 | Ex. 11 | 2.34124 | 0.27941 |
| 20 | Ex. 9 | 2.34865 | 0.27805 |
| 21 | — | 2.36378 | 0.276968 |
| 22 | Ex. 4 | 2.34398 | 0.27932 |
| 23 | Ex. 5 | 2.41263 | 0.27472 |

The measurement of examples 14, 15, 16, 17, 18, 19, 20, 21, 22 and 23 are detailed in Table 4.

TABLE 4

| | | Storage Modulus | Onset ‘gel’ |
|---|---|---|---|
| Ex. No. | Additive | Plateau (MPa)b | temp (° C.) |
| 14 | — | 10.5 | 131.7 |
| 15 | Ex. 1 | 12.2 | 132.5 |
| 16 | Ex. 2 | 23.4 | 133.4 |
| 17 | Ex. 3 | 10.9 | 133.3 |
| 18 | Ex. 13 | 12.4 | 130.9 |
| 19 | Ex. 11 | 10.9 | 131.3 |
| 20 | Ex. 9 | 14.2 | 133.8 |
| 21 | — | 23.6 | 135* |
| 22 | Ex. 4 | 30.9 | 135* |
| 23 | Ex. 5 | 55.8 | 134.6* |

*Temperature of gel occurred during isothermal region of the temperature hold in the experiment.

In Table 4, Examples 14, 15, 16, 17, 18, 19 and 20 show very little variation in onset gel temperature, showing the coupling agents present have no effect on the curing kinetics of the resin. Examples 15, 16 and 17 show increases in the modulus measured, in the plateau region after cure, in comparison to identical, but coupling agent free formulation, Example 14. Example 18, 19 and 20 also show increases in the modulus measured over comparative example 14, however in this case the formulations are non-identical (filler and fibre has changed for these examples). Examples 21, 22 and 23 have a different level of promoter/accelerator to Examples 14 through to 20 and cut fibre rather than milled. The small change in promoter/accelerator loading is accompanied by a change in gel time into the temperature hold region for the experiment. However, in this set, coupling agent containing formulations, Examples 22 and 23, show little change in there comparative onset temperature and also show a higher modulus than comparative formulation, Example 21.

Examples 24 and 25: Example 12 was incorporated into a dispersion containing calcium carbonate (Carbital™ 110s ex Imerys), glass bubbles (S32HS ex 3M) and milled glass fibre (1320K ex Owens Corning) in an unsaturated polyester resin (Palapreg® P17-02 ex AOC) and polystyrene low profile additive (Norpol® LP 9887-A ex Reichold). Additionally, a thickner (Luvatol® MK25 ex Luvatol) and zinc stearate (Sigma Aldrich) were added to the mixtures. The formulation included a peroxide cure catalyst (tert-butylperoxy benzoate ex Sigma Aldrich). Formulations were prepared mixing for a total of time of 16 mins on a planetary centrifugal mixer at 2,000 rpm allowing the sample to cool to room temperature every 2 mins. Table 5 details the % by weight of each component in Examples 24 and 25. Example 25 represents a typical formulation that may be used for compression moulding of light weight GFRP body panels for vehicles and other transportation purposes.

TABLE 5

| | Ex. 24 | Ex. 25 |
|---|---|---|
| Example 12 | | 1.1 |
| Palapreg P17-02 | 28.9 | 28.6 |
| Norpol LP 9887-A | 19.2 | 19.0 |
| Carbital 110S | 9.6 | 9.5 |
| Glass Bubbles | 7.2 | 7.1 |
| Tert-butyl benzoylperoxide | 0.7 | 0.7 |
| Milled Glass fibre (1320 K) | 32.7 | 32.3 |
| Luvatol MK25 | 0.9 | 0.9 |
| Zinc Stearate | 0.7 | 0.7 |

For Examples 24 and 25, a temperature ramp from 25-135° C. at 5° C./min. Holding at 135° C. for 3 mins to continue measurement post sample cure. Initial gap size was 1000 μm with a trim offset of 50 μm giving a minimum sample volume at test start of 0.49087 mL. A gap temperature compensation-expansion coefficient of 2.7398 μm/° C., compliance of 2.02 mrad/N·m, for Example 24 geometry inertia 2.36008 μN·m·s² and friction 0.27782 μN·m/(rad/s); for Example 25 geometry inertia 2.36547 μN·m·s² and friction 0.276771 μN·m/(rad/s); for both examples stress constant 325949 Pa/N·m, strain constant 12.5 1/rad and normal stress constant 4074.37 Pa/N. The measurement of Examples 24 and 25 is detailed in Table 6.

TABLE 6

| | | Storage Modulus | Onset ‘gel’ |
|---|---|---|---|
| | Additive | Plateau (MPa)^{b} | temp (° C.) |
| Ex. 24 | blank | 14.4 | 108.4 |
| Ex. 25 | Ex. 12 | 17.2 | 109.9 |

Direct comparison of Example 25 to 24 shows only minor changes in the onset gel time and an increase in the storage modulus in the plateau region after cure.

Example 10 was incorporated into a dispersion containing talc (TL-3 ex International) and milled glass fibre (1320K ex Owens Corning) in a vinyl ester resin (Crystic® VE 676 ex Scott Bader) containing dimethylanaline (Sigma Aldrich) and cobalt ethylhexanoate solution (Sigma Aldrich). The formulations were prepared mixing for a total of time of 8 mins on a planetary centrifugal mixer at 2,000 rpm allowing the sample to cool to room temperature every 2 mins. Exactly 5 minutes prior to running in the below described experiments for each example, a peroxide cure catalyst (tert-butylperoxy benzoate ex Sigma Aldrich) was mixed into the formulation on a planetary centrifugal mixer at 2,000 rpm for 30 seconds. Table 7 details the % by weight of each component in the tested formulations for Examples 26 and 27. Examples 26 and 27 represents a typical formulation that may be used for GFRP repairs in marine or industrial applications.

TABLE 7

| | Ex. 26 | Ex. 27 |
|---|---|---|
| Example 10 | | 0.6 |
| MEKP (4 PHR) | 1.3 | 1.4 |
| Crystic VE 676 | 32.6 | 32.4 |
| Dimethylanaline | 0.7 | 0.7 |
| Cobalt ethylhexanoate solution | 0.3 | 0.3 |
| Talc (TL-3) | 48.7 | 48.4 |
| Milled glass fibre (1320 K) | 16.3 | 16.2 |

For Examples 26 and 27, a temperature hold at 40° C., holding at 40° C. for 1 hr at temperature during measurement was used. Initial gap size was 1500 μm with a trim offset of 50 μm giving a minimum sample volume at test start of 0.736311 mL. A gap temperature compensation—expansion coefficient of 2.7398 μm/° C., compliance of 2.02 mrad/N·m, for example 26 geometry inertia 2.40223 μN·m·s², friction 0.275298 μN·m/(rad/s); for Example 27 geometry inertia 2.32433 μN·m·s², friction 0.280915 μN·m/(rad/s); for both examples stress constant 325949 Pa/N·m, strain constant 12.5 1/rad and normal stress constant 4074.37 Pa/N. The measurement of Examples 26 and 27 is detailed in Table 8.

TABLE 8

| | | Storage Modulus | Endset ‘Cure’ |
|---|---|---|---|
| | Additive | Plateau (MPa)^{a} | time (sec) |
| Ex. 26 | blank | 29.3 | 221 |
| Ex. 27 | Ex. 10 | 30.3 | 753 |

Comparison of Example 27 to 26, shows a slight increase in modulus in the plateau region after cure in this instance, some latency is observed in the cure kinetics. For some applications, controlled latency in curing can be advantageous for processing.

Example 11 was incorporated into a homogeneous mixture of metakaolin (Metaever® O ex NewChem) and standardised quartz sand (ASTM C77820-30 ex Howie & Howie Ltd) in part A of a polyurethane casting resin (Xencast® P6 Toughned PU Part A ex Xencast polymers). Formulation was prepared mixing for a total of time of 6 mins on a planetary centrifugal mixer at 2,000 rpm allowing the sample to cool to room temperature every 2 mins. This was then mixed into part B of the polyurethane casting resin (Xencast® P6 Toughned PU Part B ex Xencast polymers), starting the mixing process 10 mins before starting the through cure experiment (described for example 28 and 29) on a planetary centrifugal mixer at 2,000 rpm for 30 seconds. Table 9 details the % by weight of each component in the tested formulation for example 28 and 29. Example 28 and 29 represents a formulation that may be used for polymer marble or polymer casting applications.

TABLE 9

| | Ex. 28 | Ex. 29 |
|---|---|---|
| Example 11 | | 0.7 |
| Xencast P6 Toughned PU Part A | 12.5 | 12.5 |
| Xencast P6 Toughned PU Part B | 12.5 | 12.6 |
| Sand (ASTM C77820-30) | 49.6 | 49.4 |
| Metakaolin (Metaever O) | 25.4 | 24.8 |

For Examples 28 and 29, a temperature hold at 50° C. was used, holding at 50° C. for 1 hr at temperature during measurement. Initial gap size was 1500 μm with a trim offset of 50 μm giving a minimum sample volume at test start of 0.736311 mL. A gap temperature compensation-expansion coefficient of 2.7398 μm/° C., compliance of 2.02 mrad/N·m, for Example 28 geometry inertia 2.40905 μN·m·s², friction 0.274824 μN·m/(rad/s); for Example 29 geometry inertia 2.35425 μN·m·s², friction 0.278082 μN·m/(rad/s); for both examples stress constant 325949 Pa/N·m, strain constant 12.5 1/rad and normal stress constant 4074.37 Pa/N. The measurement of Examples 26 and 27 is detailed in Table 10.

TABLE 10

| | | Storage Modulus | Endset ‘Cure’ |
|---|---|---|---|
| | Additive | Plateau (MPa)^{a} | time (sec) |
| Ex. 28 | blank | 15.9 | 2149 |
| Ex. 29 | Ex. 11 | 19.6 | 2173 |

Comparison of Example 29 to 28 shows an increase in the storage modulus plateau after cure. This is accompanied by minimal changes in the endset cure time.

For all examples in relation to their respective comparative examples, increases in the storage moduli our observed. This shows formulations containing the coupling agents are stiffer, this infers a greater density of crosslinks within the cured compound matrix and to the filler and fibres within it.

Except in the Examples, or where otherwise explicitly indicated or required by context, all numerical quantities in this description specifying amounts of materials, reaction conditions, molecular weights, number of carbon atoms, and the like, are to be understood as modified by the word “about”. As used herein, the term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value. In other embodiments, the value is within a range of the explicitly-described value which would be understood by those of ordinary skill, based on the disclosures provided herein, to perform substantially similarly to compositions including the literal amounts described herein.

It is to be understood that the upper and lower amount, range, and ratio limits set forth herein may be independently combined, and that any amount within a disclosed range is contemplated to provide a minimum or maximum of a narrower range in alternative embodiments (with the proviso, of course, that the minimum amount of a range must be lower than the maximum amount of the same range). Similarly, the ranges and amounts for each element of the subject matter disclosed herein may be used together with ranges or amounts for any of the other elements.

While certain representative embodiments and details have been shown for the purpose of illustrating the subject matter disclosed herein, it will be apparent to those skilled in this art that various changes and modifications may be made therein without departing from the scope of the subject matter. In this regard, the scope of the invention is to be limited only by the following claims.

1. A thermoset composition comprising a dispersion of a particulate solid into a thermosetting resin in the presence of a coupling agent comprising monomeric units a, b, c, d, and e according to formula I: 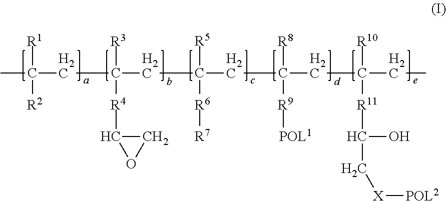
wherein, independently for each molecule of the coupling agent:
R¹ is H or CH₃;
R² is H, a C₁ to C₂₀ alkyl group, a C₆ to C₁₀ aryl group, a C₇ to C₁₄ alkaryl group, or a C₄ to C₆ cycloalkyl group;
R³ is H or CH₃;
R⁴ is a C₁ to C₂₀ alkyl group, —C—O—R¹²—, or —(C═O)—O—C—R¹²—, wherein R¹² is a C₁ to C₂₀ alkyl group;
R⁵ is H or CH₃;
R⁶ is —C—O— or —(C═O)—O—C—;
R⁷ is a C₁ to C₂₀ alkyl group;
R⁸ is H or CH₃;
R⁹ is a C₁ to C₂₀ alkyl group, —C—O—R¹⁴—, or —(C═O)—O—C—R¹⁴—, wherein R¹⁴ is a C₁ to C₂₀ alkyl group;
R¹⁰ is H or CH₃;
R¹¹ is a C₁ to C₂₀ alkyl group, —C—O—R¹⁵—, or —(C═O)—O—C—R¹⁵—, wherein R¹⁵ is a C₁ to C₂₀ alkyl group;
POL¹ is a polymer comprising at least one of a polyether or a polyester, wherein the polymer has a theoretical-number-average molecular weight of from 200 to 3,000;
POL² is a polymer comprising at least one of a polyether or a polyester, wherein the polymer has a theoretical-number-average molecular weight of from 200 to 3,000;
X is S, O, NH, or —O—(C═O)—;
a is an integer from 1 to 500;
b is an integer from 1 to 500;
c is 0, or an integer from 1 to 100;
d is 0, or an integer from 1 to 100; and
e is 0, or an integer from 1 to 100;
with the proviso that if d is greater than 0, e is 0, and if e is greater than 0, d is 0.

2. The thermoset composition of claim 1, wherein the particulate solid is present in an amount of from 20 to 80 weight percent, based on the total weight of the thermoset composition.

3. (canceled)

4. (canceled)

5. (canceled)

6. The thermoset composition of claim 1, wherein the functional filler comprises at least one of flame retardant materials or pigments.

7. The thermoset composition of claim 1, wherein the thermosetting resin is present in an amount of from 80 to 20 weight percent, based on the total weight of the thermoset composition.

8. The thermoset composition of claim 1, wherein the thermosetting resin comprises an epoxide resin, an unsaturated polyester resin, a vinyl ester resin, a polyurethane resin, or a phenolic resin.

9. The thermoset composition of claim 1, wherein the coupling agent is present in an amount of from 0.5 to 5 weight percent, based on the total weight of the thermoset composition.

10. The thermoset composition of claim 1, wherein the coupling agent comprises at least 90 percent by weight monomeric units a, b, c, d, and e, according to formula I, based on the total weight of the coupling agent.

11. The thermoset composition of claim 1, wherein the coupling agent comprises at least 70 percent by weight monomeric units a and b, according to formula I, based on the total weight of the coupling agent.

12. The thermoset composition of claim 1, wherein the coupling agent comprises no more than 30 percent by weight monomeric units c, d, and e, according to formula I, based on the total weight of the coupling agent.

13. The thermoset composition of claim 1, wherein the coupling agent comprises at least 50 percent by weight monomeric units a, according to formula I, based on the total weight of the coupling agent.

14. The thermoset composition of claim 1, wherein the coupling agent comprises no more than 40 percent by weight monomeric units b, according to formula I, based on the total weight of the coupling agent.

15. The thermoset composition of claim 1, wherein a is an integer from 5 to 500.

16. The thermoset composition of claim 1, wherein a is an integer from 10 to 300.

17. The thermoset composition of claim 1, wherein b is an integer from 2 to 100.

18. The thermoset composition of claim 1, wherein b is an integer from 5 to 80.

19. The thermoset composition of claim 1, wherein the ratio of a to b is from 1:1 to 10:1.

20. The thermoset composition of claim 1, wherein c is an integer from 1 to 20.

21. The thermoset composition of claim 1, wherein: (i) d is 0, or an integer from 1 to 20; and (ii) e is 0, or an integer from 1 to 20; with the proviso that if d is greater than 0, e is 0, and if e is greater than 0, d is 0.

22. The thermoset composition of claim 1, wherein the coupling agent comprises up to 10 percent by weight other monomeric units, different from monomeric units a, b, c, d, and e according to formula I.

23. The thermoset composition of claim 22, wherein the other monomeric units are vinyl-functional monomeric units.
